(19) United States
(12) Patent Application Publication
(10) Pub. No.: US 2015/0288953 A1
(43) Pub. Date: Oct. 8, 2015

(54) Stereo Image Processing Device and Stereo Image Processing Method

(71) Applicant: HITACHI AUTOMOTIVE SYSTEMS, LTD., Hitachinaka-shi, Abaraki (JP)

(72) Inventor: Shinji Kakegawa, Tokyo (JP)

(21) Appl. No.: 14/436,839

(22) PCT Filed: Oct. 2, 2013
(86) PCT No.: PCT/JP2013/076757

§ 371 Date: Apr. 17, 2015

(30) Foreign Application Priority Data
Oct. 19, 2012 (JP) 2012-231501

(51) Int. Cl. H04N 13/02; G08G 1/16; G06K 9/00

(52) U.S. Cl. CPC H04N 13/0282; G06K 9/00805; G08G 1/166; H04N 2013/0081

(57) ABSTRACT

To provide a stereo image processing device and a stereo image processing method that can suppress a decrease in the determination accuracy of parallax for an identical object due to mixture of noise and the like, the device includes a pair of imaging units 101a, 101b; a similarity calculation unit 106b that calculates similarity for each parallax for the pair of images; a parallax calculation unit 106c that calculates parallax for an identical object on the basis of the similarity for each parallax; a parallax data buffer unit 105 that stores data on the parallax; a speed detection unit 107 that detects a moving speed of the pair of imaging units 101a, 101b; and a parallax prediction unit 106a that calculates a predicted parallax value on the basis of the moving speed and past data on parallax stored in the parallax data buffer unit 105. The parallax calculation unit 106 calculates parallax for an identical object on the basis of the similarity for each parallax and the predicted parallax value.

### TECHNICAL FIELD

The present invention relates to a stereo image processing device and a stereo image processing method for, on the basis of a pair of images captured with a pair of imaging units, calculating parallax for an identical object contained in the images.

### BACKGROUND ART

Patent Literature 1 discloses an object detecting system including stereo-image taking means for outputting a reference image T_{O} and a comparative image T_{C}, stereo matching means for performing a stereo matching process, object detecting means for detecting an object O in the reference image To, estimated-region setting means for setting, in the reference image To and the comparative image T_{C}, estimated regions R_{Oest} and R_{Cest} where images of the object O are expected to be taken in a current frame, on the basis of the distance Z of the object O in the reference image To in the previous frame and the like, and determination means for, if the absolute value of the difference between the average luminance values p1ᵢⱼ_{_{—}}ₐᵥₑ and p2ᵢⱼ_{_{—}}ₐᵥₑ of the estimated regions is more than or equal to a predetermined threshold value Δₚₜₕ, correlating information about the object O detected in the estimated region R_{Oest} of the reference image To or information that the object O is not detected, with information that noise is included.

### CITATION LIST

### Patent Literature

Patent Literature 1: JP 2009-110173 A

### SUMMARY OF INVENTION

### Technical Problem

By the way, with respect to a stereo image processing device, which searches images captured with left and right cameras for similar image regions and performs matching therebetween to measure parallax for an identical object or the distance to the object, if there is a plurality of similar image regions other than the real matching regions in the search range, there is a possibility that the matching may fail, which can increase determination errors of parallax for an identical object (i.e., calculation errors of the distance).

Factors that regions other than the real matching regions are erroneously determined as similar regions include, for example, a factor that there is a plurality of similar image regions in the search range and a factor that noises of the left and right cameras (e.g., dirt sticking to the camera lenses or noises of the image signal processing circuit) that are at unequal levels are mixed.

If determination errors of parallax for an identical object are increased, problems, such as a decrease in the measurement accuracy of the distance and an increase of erroneous detection of obstacles, would occur.

The present invention has been made in view of the foregoing. It is an object of the present invention to provide a stereo image processing device and a stereo image processing method that can suppress a decrease in the determination accuracy of parallax for an identical object due to mixture of noise and the like.

### Solution to Problem

Therefore, a stereo image processing device of the present invention includes a pair of imaging units; a similarity calculation unit configured to receive a pair of images captured with the pair of imaging units and calculate similarity for each parallax for the pair of images; a parallax calculation unit configured to calculate parallax for an identical object on the basis of the similarity for each parallax; a parallax data buffer unit configured to store data on the parallax calculated with the parallax calculation unit; a speed detection unit configured to detect a moving speed of the pair of imaging units; and a parallax prediction unit configured to calculate a predicted parallax value on the basis of the moving speed and past data on parallax stored in the parallax data buffer unit. The parallax calculation unit is configured to calculate parallax for an identical object on the basis of the similarity for each parallax and the predicted parallax value.

In addition, a stereo image processing method of the present invention includes calculating similarity for each parallax for a pair of images captured with a pair of imaging units; calculating a predicted parallax value on the basis of past data on parallax for an identical object and a moving speed of the pair of imaging units; and calculating parallax for the identical object on the basis of the similarity for each parallax and the predicted parallax value.

### Advantageous Effects of Invention

According to the present invention, it is possible to, even when there is a plurality of similar image regions other than the real matching regions in the search range, suppress matching errors by adding information on the moving speed of the pair of imaging units, thereby improving the calculation accuracy of parallax for the identical object.

### BRIEF DESCRIPTION OF DRAWINGS

FIG. 1 is a block diagram showing a stereo image processing device in accordance with an embodiment of the present invention.

FIG. 2 is a diagram for illustrating a method of calculating corresponding pixel positions in time series in accordance with an embodiment of the present invention.

FIG. 3 is a diagram for illustrating a method of predicting parallax in accordance with an embodiment of the present invention.

FIG. 4 is a diagram for illustrating a method of calculating similarity in accordance with an embodiment of the present invention.

FIG. 5 is a diagram for illustrating a process of weighting similarity in accordance with an embodiment of the present invention.

FIG. 6 is a diagram for illustrating triangulation in accordance with an embodiment of the present invention.

### DESCRIPTION OF EMBODIMENTS

Hereinafter, embodiments of the present invention will be described with reference to the drawings.

This embodiment will describe an exemplary driving assisting system that detects an object, such as a preceding vehicle, using a pair of images captured with a pair of imaging units that are mounted on a vehicle, as an example of a stereo image processing device and a stereo image processing method in accordance with the present invention.

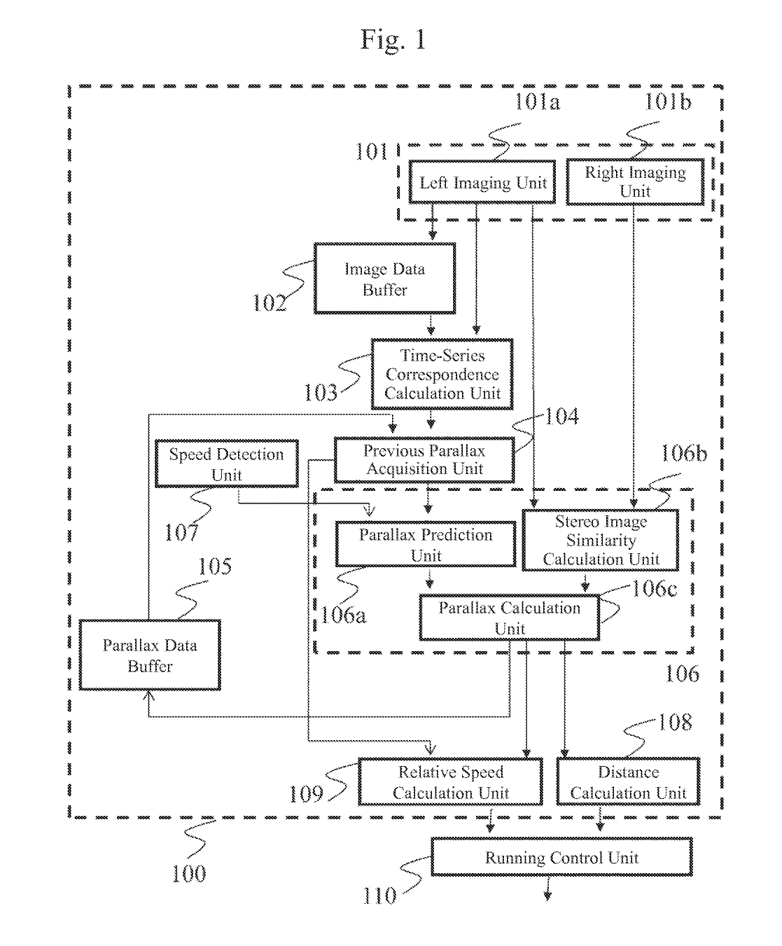

FIG. 1 is a block diagram showing the configuration of the aforementioned driving assisting system.

In FIG. 1, the driving assisting system includes a stereo image processing device 100 and a running control unit 110. The stereo image processing device 100 detects the relative distance to and the relative speed of an object (i.e., preceding vehicle) contained in the images through image processing, while the running control unit 110 performs vehicle running control, such as cruise control, on the basis of information on the relative distance and the relative speed.

Examples of the cruise control include accelerator control (i.e., throttle control), brake control, and the like that are performed on the basis of information on the relative speed of a preceding vehicle, the distance to the preceding vehicle, and the like so as to maintain a preset vehicle speed and distance between the vehicles.

It is also possible to provide a warning unit that issues warnings (i.e., calls attention) to a driver on the basis of information on the relative distance to and the relative speed of an object and the like instead of or together with the running control unit 110.

The stereo image processing device 100 includes an imaging device 101. The imaging device 101 includes a pair of imaging units (i.e., cameras) 101a and 101b that capture images of a region ahead of one's vehicle. The pair of imaging units 101a and 101b are installed on one's vehicle (e.g., on the inner side of the windshield) so as to capture images of a region ahead of the vehicle from positions where the imaging units are located apart from each other in the vehicle width direction.

The left imaging unit 101a, which is provided on the left side when facing a region ahead of the vehicle, outputs the captured left image, while the right imaging unit 101b, which is provided on the right side when facing a region ahead of the vehicle, outputs the captured right image.

The stereo image processing device 100 includes, in addition to the imaging device 101, an image data buffer unit 102, a time-series correspondence calculation unit 103, a previous parallax acquisition unit 104, a parallax data buffer unit 105, a stereo correspondence calculation unit 106, a speed detection unit 107, a distance calculation unit 108, and a relative speed calculation unit 109.

The image data buffer unit 102 has a function of holding the left image output from the left imaging unit 101a for a time corresponding to one frame, for example, and outputs the previous left image, which is a left image of the previous frame, in processing each frame.

The time-series correspondence calculation unit 103 receives the previous left image (i.e., previous frame) output from the image data buffer unit 102 and the current left image (i.e., current frame) output from the left imaging unit 101a, and calculates, for each pixel of the current left image, a pixel position on the previous left image that contains the same object region.

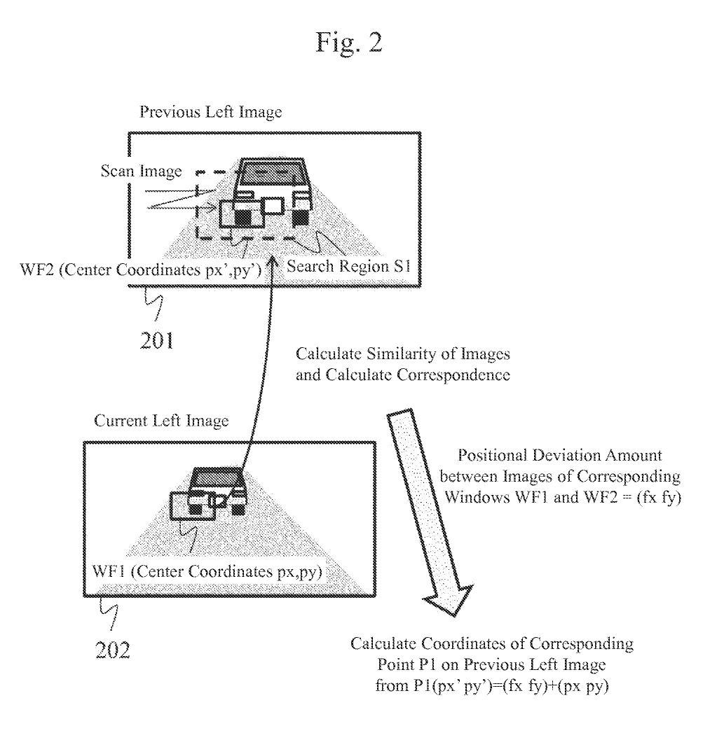

Hereinafter, a process of the time-series correspondence calculation unit 103 will be described with reference to FIG. 2.

The time-series correspondence calculation unit 103 receives a previous left image 201 output from the image data buffer unit 102 and a current left image 202 that is a left image currently input from the left imaging unit 101a.

Then, the time-series correspondence calculation unit 103 sets, for each pixel of the current left image 202, a window WF1 of a nearby region Np of 3×3 pixels or 9×9 pixels, for example, and similarly sets, for all pixels of a search region S1 on the previous left image 201, a window WF2 of a nearby region Np with the same shape as the window WF1, and then calculates the SAD value (Sum of Absolute Difference) for the window WF1 and the window WF2 in accordance with Formula 1.

Herein, the SAD value is an index value for evaluating the difference between the luminance values of the two images. If the SAD value is zero, it means that the two images (i.e., the previous left image 201 and the current left image 202) are identical. Instead of the SAD value, the SSD value (Sum of Squared Difference) can also be calculated.

$$SAD ( P , P ) = {\sum }_{Q ∈ Np} \vert {I}_{aft} ( Q ) - {I}_{pre} ( Q + P ) \vert \qquad [ Formula 1 ]$$

In Formula 1, symbol P represents the pixel position [Px,Py]^{T} on the current left image 202 from which the SAD value is calculated, that is, the center coordinates of the window WF1; symbol F represents the positional deviation amount [fx,fy]^{T} between the images of the window WF1 and the window WF2; symbol Q represents the pixel position in the nearby region Np that includes the pixel position [Px,Py]^{T} at the center; symbol I_{aft}( ) represents the luminance value of the current left image 202 at the pixel position in the parentheses, and symbol I_{pre( )} represents the luminance value of the previous left image 201 at the pixel position in the parentheses.

Next, the time-series correspondence calculation unit 103 determines the inverse number of the SAD value as an index value of image similarity, and calculates the pixel position P1 on the previous left image 201, from which the highest image similarity (i.e., minimum SAD value) has been calculated, as [Px,Py]^{T}+[fx,fy]^{T}.

That is, the time-series correspondence calculation unit 103 is adapted to search the previous left image 201 for the same pixel position as that in the current left image 202 through so-called template matching, and determines, by setting the window WF1 of the current left image 202 as the base image and moving the window WF2 in the search region S1 set on the previous left image 201, the similarity between the window WF1 and the window WF2 from the difference between the luminance values.

Then, regarding a combination of the window WF1 and the window WF2, for which the highest similarity has been determined, as a combination of the same object images, the time-series correspondence calculation unit 103 detects at which position on the previous left image 201 the object image contained in the current left image 202 is located, that is, movement of the object between the two adjacent frames.

Accordingly, it can be regarded that the pixel position P1 on the previous left image 201 corresponding to the pixel position [Px,Py]^{T} on the current left image 202 is [Px,Py]^{T}+[fx,fy]^{T}, and the object imaged at the pixel position [Px,Py]J and the object imaged at the pixel position P1=[Px,Py]^{T}+[fx,fy]^{T} are the same.

When the time-series correspondence calculation unit 103 identifies a pixel on the previous left image 201 corresponding to each pixel of the current left image 202 as described above, information on the pixel is output to the previous parallax acquisition unit 104.

Meanwhile, the parallax data buffer unit 105 stores parallax data (i.e., parallax for an identical object) for each pixel of the previous left image 201 that has been measured from the previous frame.

The previous parallax acquisition unit 104, by referring to a table of parallax data on the previous frame on the basis of the pixel position P1 on the previous left image 201, that is, the deviation amount [fx,fy]^{T} of the corresponding pixel position, acquires data on parallax (i.e., parallax in the past) determined from each pixel of the previous left image 201 corresponding to each pixel of the current left image 202, that is, data on parallax that has been previously detected for the identical object.

It should be noted that the pixel position P can be a subpixel position including a decimal part. Thus, when the table of parallax data on the previous frame is referred to, the decimal part of the pixel position P1 is round off to the nearest integer, for example.

The stereo correspondence calculation unit 106 includes a parallax prediction unit 106a, a stereo image similarity calculation unit 106b, and a parallax calculation unit 106c.

The parallax prediction unit 106a calculates, for each pixel of the current left image 202, predicted parallax d_{fo} that is predicted to be measured from the current frame for an identical object in accordance with Formula 2, using parallax in the previous frame output from the previous parallax acquisition unit 104 and speed information on one's vehicle output from the speed detection unit 107.

In Formula 2, symbol f represents the focal length of the imaging units 101a and 101b, symbol c represents the pixel size of the imaging units 101a and 101b, symbol B represents the distance between the left and right cameras of the stereo imaging device 101, symbol dₚᵣₑ represents parallax in the previous frame, symbol z represents the speed of one's vehicle, and symbol dt represents the frame period.

$${d}_{fo} = \frac{f \cdot c \cdot B}{f \cdot c \cdot B - z \cdot dt \cdot {d}_{pre}} {d}_{pre} \qquad [ Formula 2 ]$$

Formula 2 is a formula for predicting parallax by assuming that each pixel of the current left image 202 is a region on which a still object is projected.

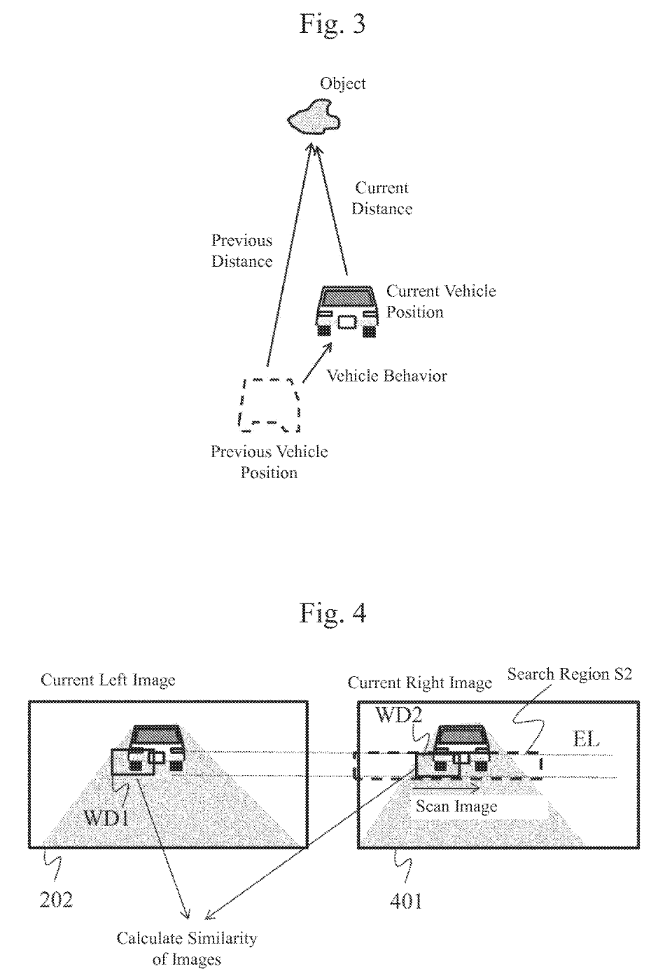

That is, as shown in FIG. 3, parallax in the previous frame corresponds to the previous distance to the object. Assuming that the object is still, the distance to the object becomes shorter than the previous value by the distance determined from the period from the previous time to the current time and the speed of one's vehicle, that is, the traveling distance of one's vehicle. Thus, parallax that is predicted to be measured from the current frame can be determined using the parallax in the previous frame and the speed of one's vehicle as variables.

As described above, the predicted parallax d_{fo} determined in accordance with Formula 2 is a value that can be applied when an object is still. When the actual object is moving, greater errors will be generated as the relative speed of the object with respect to one's vehicle is higher. Thus, the parallax prediction unit 106a calculates an error of the predicted parallax dr, that is generated when the actual object is moving as a predicted variation e_{d} in accordance with Formulae 3 and 4.

e_{d}=d_{foe}−d_{fo}

$${d}_{foe} = \frac{f \cdot c \cdot B}{f \cdot c \cdot B - ( z + {z}_{max} ) \cdot dt \cdot {d}_{pre}} {d}_{pre} \qquad [ Formula 4 ]$$

In Formula 4, symbol Zₘₐₓ represents a preset maximum speed in the direction opposite to the speed direction of one's vehicle. As Zₘₐₓ, the value of the estimated maximum speed of an oncoming vehicle, such as 100 (km/h) or 150 (km/h), for example, is set.

Parallax d_{foe} calculated in Formula 4 is parallax that is predicted when an object, which moves at the preset maximum speed in the direction opposite to the speed direction of one's vehicle, is projected onto each pixel of the current left image 202.

That is, the predicted parallax d_{fo} is the parallax that is predicted when an object is assumed to be stopping, while the predicted parallax d_{foe} is the parallax that is predicted when an object is assumed to be approaching one's vehicle at the estimated maximum speed, that is, when the relative speed is assumed to be maximum.

When an object is approaching one's vehicle at the estimated maximum speed, a deviation between the predicted parallax d_{fo}, which has been determined by assuming that the object is stopping, and the actual parallax becomes maximum. Thus, the predicted variation e_{d} is the maximum error estimated for the predicted parallax d_{fo}.

Meanwhile, the stereo image similarity calculation unit 106b calculates the image similarity between each pixel of the current left image 202 and a pixel, which can correspond thereto, of the current right image through a so-called stereo matching process.

Hereinafter, a process of calculating image similarity with the stereo image similarity calculation unit 106b will be described with reference to FIG. 4.

The stereo image similarity calculation unit 106b sets a left image window WD1 of a nearby region Np, such as 3×3 pixels or 9×9 pixels, for example, around each pixel of the current left image 202 as the center, and also sets a right image window WD2 with the same shape as the left image window WD1 in a search region S2 on the epipolar lines EL (i.e., search lines) in the current right image 401 that can correspond to the left image window WD1.

Then, the stereo image similarity calculation unit 106b calculates the SAD value (Sum of Absolute Difference) between the left image window WD1 and all right image windows WD2 in the search region S2 in accordance with Formula 5, and further calculates an inverse number of the SAD value as the image similarity.

$$SAD ( P , D ) = {\sum }_{Q ∈ Np} \vert {I}_{L} ( Q ) - {I}_{r} ( Q - D ) \vert \qquad [ Formula 5 ]$$

In Formula 5, symbol P represents the pixel position [Px,Py]^{T} on the current left image 202 from which the SAD value is calculated; symbol D represents the positional deviation amount [d,0]^{T} (d represents parallax that is the difference of the x coordinates) between the images of the window WD1 and the window WD2; symbol Q represents the pixel position in the nearby region Np that includes the pixel position [Px,Py]^{T} at the center; and symbol I_{L}( ) represents the luminance value of the current left image 202 at the pixel position in the parentheses, and Iᵣ( ) represents the luminance value of the current right image 401 at the pixel position in the parentheses.

In order to calculate the image similarity between a given pixel p of the current left image 202 and all pixels, which can correspond thereto, of the current right image 401, the SAD value (i.e., image similarity) is calculated in accordance with Formula 5 for all possible ranges of the parallax d.

For example, the SAD value (i.e., image similarity) is calculated in accordance with Formula 5 by shifting the parallax d one by one in the range of d=0 to 128, whereby 129 image similarities are obtained for each pixel. Such calculation of similarity is performed for all pixels of the current left image 202.

Herein, parallax that corresponds to the highest image similarity is determined as the parallax for an identical object. However, there is a possibility that image similarity of regions other than the real matching regions may become high due to the influence of noise. In such a case, parallax for an identical object may be erroneously determined.

Thus, in order to suppress the influence of noise, the parallax calculation unit 106c determines the parallax for an identical object as follows.

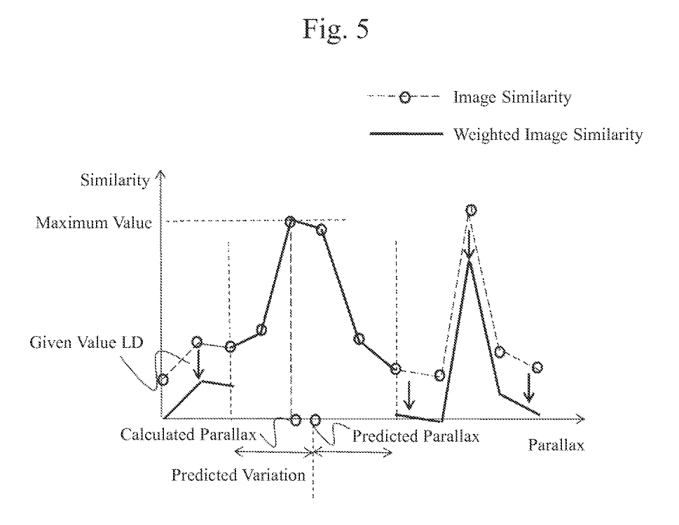

As shown in FIG. 5, the parallax calculation unit 106c weights the image similarity between each pixel of the current left image 202 and all pixels, which can correspond thereto, of the current right image 401, which has been calculated with the stereo image similarity calculation unit 106b, and detects parallax that indicates the highest similarity of all the weighted similarities as the parallax for an identical object.

According to such weighting, when the absolute value of the difference between the currently calculated parallax and the predicted parallax d_{fo} calculated with the parallax prediction unit 106a is greater than the predicted variation e_{d}, correction is performed by lowering the image similarity by a given value LD, thereby lowering the weight assigned to the similarity that corresponds to the parallax having a deviation of more than the predicted variation e_{d} relative to the predicted parallax d_{f0}.

Then, a process of determining parallax that corresponds to the highest corrected similarity (i.e., weighted image similarity) as the parallax for an identical object is performed for each pixel of the current left image 202.

That is, a predicted parallax range including the predicted parallax d_{fo}, which is interposed between the predicted parallax d_{fo}+predicted variation e_{d} and the predicted parallax d_{fo}−predicted variation e_{d}, is set. When parallax is outside such predicted parallax range, it is assumed that there is a possibility that a plurality of similar image regions may be contained in the search range, or image similarity may have been erroneous calculated due to the influence of noise. Thus, correction of lowering the similarity is performed to lower the weight. Meanwhile, when parallax is within the predicted parallax range, it is assumed that the image similarity has been performed without the influence of noise. Thus, such image similarity is excluded from the target of correction of lowering the weight, so that the weight assigned thereto becomes relatively high.

Thus, instead of uniformly lowering the image similarity for parallax that is outside the predicted parallax range, it is also possible to uniformly increase the image similarity for parallax that is within the predicted parallax range. Meanwhile, it is also possible to uniformly increase the image similarity for parallax that is within the predicted parallax range while at the same time uniformly lowering the image similarity for parallax that is outside the predicted parallax range.

Further, any configuration is acceptable as long as the weight assigned to the image similarity is lowered as the absolute value of a deviation from the predicted parallax d_{fo} becomes higher. Thus, the width (LD) of lowering the image similarity can be gradually increased with an increase in the absolute value of the deviation.

The predicted parallax d_{fo} can be determined by assuming that an object is still as described above. However, even when the actual object is moving and moving at the maximum relative speed, the currently determined parallax is estimated to be within the range of ±predicted variation e_{d}.

Thus, when similarity for parallax that is outside the predicted parallax range is high, there is a possibility that a plurality of similar image regions may be contained in the search range, or there is influence of noise. Thus, the weight assigned to the similarity is lowered to suppress the possibility that the parallax that is outside the predicted parallax range may be detected as the parallax for an identical object (i.e., extracted as the highest similarity).

Accordingly, when a plurality of similar image regions is contained in the search range or when noises at unequal levels are mixed into a pair of images due to dirt sticking to the lenses of the imaging units 101a and 101b, superposition of noises on the image signals, and the like, it is possible to suppress erroneous determination of the parallax for an identical object, that is, erroneous determination of the distance to the object (i.e., preceding vehicle).

In the case of a vehicle driving assisting system in which the imaging units 101a and 101b are installed on the inner side of a windshield of a vehicle, dirt on the windshield may cause erroneous detection of parallax (i.e., distance). However, as described above, it is possible to, by lowering the weight that is assigned to the similarity for parallax having a predetermined deviation or more from the predicted value, suppress erroneous detection of the parallax for an identical object due to the influence of dirt on the windshield.

Thus, when cruise control of controlling the vehicle speed is performed, the distance to a preceding vehicle can be precisely controlled to a preset distance on the basis of the parallax for the identical object, that is, the distance to the object (i.e., preceding vehicle).

It should be noted that as described above, the predicted variation e_{d} is not limited to the configuration in which the predicted variation e_{d} is calculated as a deviation between the predicted parallax for when an object is assumed to be moving at the maximum relative speed and the predicted parallax for when an object is assumed to be stopping. In addition, it is also possible to set the predicted variation e_{d} on the positive side and the predicted variation C_{d} on the negative side to different values.

Further, it is also possible to set the predicted variation e_{d} (i.e., predicted parallax range) not uniformly for all pixels but to a different value in accordance with the pixel position (i.e., image region).

When the predicted variation e_{d} that differs in accordance with the pixel position (i.e., image region) is set, it is possible to set the predicted variation e_{d} (i.e., predicted parallax range) that differs in accordance with the difference in the estimated maximum relative speed between, of the image region, a region in which an image of a preceding vehicle is contained and a region in which an image of an oncoming vehicle is contained.

It is also possible to set a predicted variation that varies in accordance with the road conditions, such as a speed limit, the presence or absence of a traffic jam, the road grade, or the radius of curvature of a road, or the running environment, such as the speed of one's vehicle (i.e., preset speed) or a preset distance between the vehicles.

When parallax for an identical object is calculated with the parallax calculation unit 106c as described above, data on the parallax is output to the parallax data buffer unit 105, the distance calculation unit 108, and the relative speed calculation unit 109.

Then, the parallax data buffer unit 105 stores the data on the parallax.

The distance calculation unit 108 converts the parallax calculated for each pixel of the current left image 202 into a distance in accordance with the principle of triangulation, and calculates, for each pixel of the current left image 202, the relative distance to an object that is contained in the corresponding pixel.

Meanwhile, the relative speed calculation unit 109 converts the parallax calculated for each pixel of the current left image 202 into a distance as with the distance calculation unit 108, and further converts the parallax in the corresponding previous frame acquired with the previous parallax acquisition unit 104 into a distance, and then calculates, for each pixel of the current left image 202, the relative distance to the object contained in the corresponding pixel by calculating the difference between the two distances.

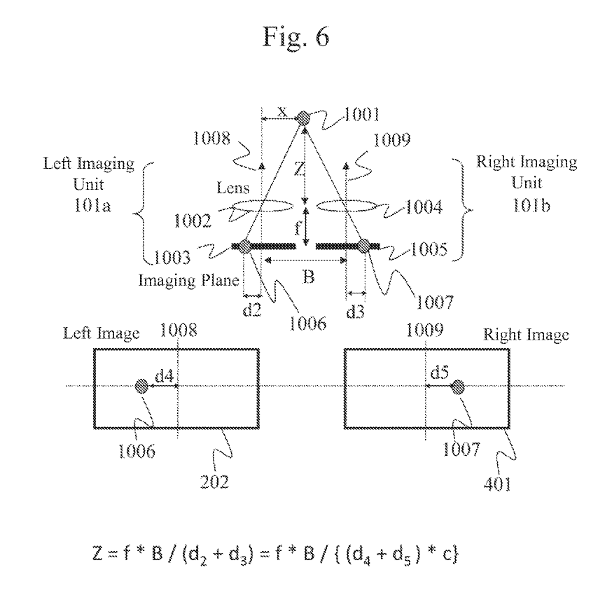

Herein, a method of calculating the relative distance will be described with reference to FIG. 6.

In FIG. 6, the left imaging unit 101a is a camera including a lens 1002 and an imaging plane 1003 and having a focal length f and an optical axis 1008. Similarly, the right imaging unit 101b is a camera including a lens 1004 and an imaging plane 1005 and having a focal length f and an optical axis 1009.

A point 1001 ahead of the camera is imaged as a point 1006 on the imaging plane 1003 of the left imaging unit 101a (at a distance of d2 from the optical axis 1008), and becomes the point 1006 on the left image 202 (at a pixel position of d4 from the optical axis 1008). Similarly, the point 1001 ahead of the camera is imaged as a point 1007 on the imaging plane 1005 of the right imaging unit 101b (at a distance of d3 from the optical axis 1009), and becomes the point 1007 on the right image 401 (at a pixel position of d5 from the optical axis 1009).

As described above, the point 1001 of an identical object is imaged at the pixel position of d4 on the left side of the optical axis 1008 on the left image 202, and is imaged at the pixel position of d5 on the right side of the optical axis 1009 on the right image 401. Thus, parallax corresponding to the pixels of d4+d5 (=parallax d determined by the parallax calculation unit 106c) is generated.

Therefore, the distance Z from the left and right imaging units 101a and 101b to the point 1001 can be determined as follows using the distance B between the optical axes of the left and right imaging units 101a and 101b.

That is, in FIG. 6, d2:f=x:D is established from the relationship between the point 1001 and the left imaging unit 101a, and d3:f=(B−x):D is established from the relationship between the point 1001 and the right imaging unit 101b. Thus, the distance Z can be calculated in accordance with the following formula:

Z=f×B(d2+d3)=f×B/{(d4+d5)×c}.

Herein, symbol c represents the size of the imaging element with the imaging plane 1003 or 1005.

As described above, the stereo image processing device 100 outputs information on the distance and the relative speed calculated for each pixel of an image, and the running control unit 110 detects an object (i.e., preceding vehicle) that exists ahead of one's vehicle on the basis of such information, and thus performs brake control and accelerator control in accordance with the relative distance to and the relative speed of the object.

The aforementioned stereo image processing device 100, when calculating the distance to a given region, calculates a predicted parallax value in advance using the distance to the region in the past (i.e., parallax for an identical object) and the speed information on the imaging device 101 (i.e., vehicle) from the past up to now, and weights the similarity in accordance with a deviation from the predicted value, and then performs matching to select the highest weighted similarity. Thus, even when a correct matching result is difficult to be obtained only with the image-based similarity information, for example, when there is a plurality of similar image regions other than the real matching regions in the search range, it is possible to perform correct matching and stably calculate the accurate distance.

Further, with respect to a far object, the number of pixels from which the distance to the object is calculated is smaller than that of a nearby object. Thus, if the distance is calculated erroneously for a part of the object, the proportion of the region of the erroneously measured distance to the entire object region becomes large. Thus, detection of the object is difficult to perform. However, as the aforementioned stereo image processing device 100 can suppress erroneous calculation of the distance, an advantageous effect is provided in that a far object can be easily detected.

It should be noted that the present invention is not limited to the aforementioned embodiments, and a variety of changes are possible within the spirit and scope of the present invention.

In the aforementioned embodiment, the image data buffer unit 102 and the time-series correspondence calculation unit 103 each perform a process only on the left image input from the left imaging unit 101a, and do not perform a process on the right image input from the right imaging unit 101b, so that the left image is used as a reference. However, the present invention is not limited to such a configuration.

For example, similar advantageous effects can be provided even when the left imaging unit 101a and the right imaging unit 101b in FIG. 1 are switched and all of the relationships between the left image and the right image are thus switched. Alternatively, the entire configuration of FIG. 1 may be made symmetrical by configuring each of the image data buffer unit 102 and the time-series correspondence calculation unit 103 to perform a process not only on one of the right or left image but on both the left and right images.

Further, it is also possible to calculate a predicted parallax value for an identical object on the basis of the speed and acceleration of the imaging device 101 (i.e., vehicle).

### REFERENCE SIGNS LIST

100 Stereo image processing device
101 Imaging device
101a Left imaging unit
101b Right imaging unit
102 Image data buffer unit
103 Time-series correspondence calculation unit
104 Previous parallax acquisition unit
105 Parallax data buffer unit
106 Stereo correspondence calculation unit
106a Parallax prediction unit
106b Stereo image similarity calculation unit
106c Parallax calculation unit
107 Speed detection unit
108 Distance calculation unit
109 Relative speed calculation unit
110 Running control unit

1.-13. (canceled)

14. A stereo image processing device comprising:
a pair of imaging units;
a similarity calculation unit configured to receive a pair of images captured with the pair of imaging units and calculate similarity for each parallax for the pair of images;
a parallax calculation unit configured to calculate parallax for an identical object on the basis of the similarity for each parallax;
a parallax data buffer unit configured to store data on the parallax calculated with the parallax calculation unit;
a speed detection unit configured to detect a moving speed of the pair of imaging units; and
a parallax prediction unit configured to calculate a predicted parallax value on the basis of the moving speed and past data on parallax stored in the parallax data buffer unit,
wherein the parallax calculation unit is configured to calculate parallax for an identical object on the basis of the similarity for each parallax and the predicted parallax value.

15. The stereo image processing device according to claim 14, wherein the parallax calculation unit is configured to weight the similarity for each parallax on the basis of the predicted parallax value.

16. The stereo image processing device according to claim 15, wherein the parallax calculation unit is configured to weight the similarity in accordance with a deviation of parallax from the predicted parallax value.

17. The stereo image processing device according to claim 16, wherein the parallax calculation unit is configured to assign a low weight to similarity corresponding to parallax that is outside a predicted parallax range including the predicted parallax value.

18. The stereo image processing device according to claim 17, wherein the parallax calculation unit is configured to set the predicted parallax range in accordance with a predicted error of parallax in accordance with a relative speed of an object with respect to the pair of imaging units.

19. The stereo image processing device according to claim 18, wherein the parallax calculation unit is configured to set the predicted parallax range in accordance with a predicted error of parallax for when the object is approaching the pair of imaging units at a preset maximum speed.

20. The stereo image processing device according to claim 15, wherein the parallax calculation unit is configured to determine parallax corresponding to the highest weighted similarity as parallax for an identical object contained in the images.

21. The stereo image processing device according to claim 14, further comprising a distance calculation unit configured to, on the basis of parallax for an identical object calculated with the parallax calculation unit, calculate a distance to the object and output the distance.

22. The stereo image processing device according to claim 14, further comprising a relative speed calculation unit configured to, on the basis of parallax for an identical object calculated with the parallax calculation unit, calculate a relative speed of the object and output the relative speed.

23. The stereo image processing device according to claim 14, wherein
the pair of imaging units are mounted on a vehicle, and
the speed detection unit is configured to detect a traveling speed of the vehicle as the moving speed.

24. A stereo image processing method, comprising:
calculating similarity for each parallax for a pair of images captured with a pair of imaging units;
calculating a predicted parallax value on the basis of past data on parallax for an identical object and a moving speed of the pair of imaging units; and
calculating parallax for the identical object on the basis of the similarity for each parallax and the predicted parallax value.

25. The stereo image processing method according to claim 24, further comprising:
setting a predicted parallax range including the predicted parallax value;
assigning a low weight to similarity corresponding to parallax that is outside the predicted parallax range; and
determining parallax corresponding to the highest similarity of the weighted similarity for each parallax, as parallax for an identical object.
